(19) United States
(12) Patent Application Publication
(10) Pub. No.: US 2026/0370694 A1
(43) Pub. Date: Nov. 19, 2026

(54) Methods And Apparatus For Setting Internet Protocol Multimedia Subsystem Calls In Mobile Communications

(71) Applicant: MediaTek Inc., Hsinchu City (TW)

(72) Inventors: Chien-Yi Wang, Hsinchu City (TW); Hao-Chen Chou, Hsinchu City (TW); Yung-Liang Tsou, Hsinchu City (TW); Yu-Ching Tung, Hsinchu City (TW)

(73) Assignee: MediaTek Inc., Hsinchu City (TW)

(21) Appl. No.: 19/636,958

(22) Filed: Apr. 2, 2026

Related U.S. Application Data
(60) Provisional application No. 63/805,374, filed on May 14, 2025.

(51) Int. Cl. H04L 65/1016; H04B 7/19; H04L 5/00; H04L 65/1104

(52) U.S. Cl. CPC H04L 65/1016; H04B 7/19; H04L 5/0053; H04L 65/1104

(57) ABSTRACT

Various solutions for reducing voice delay in Internet Protocol Multimedia Subsystem (IMS) call setup are described. A called user equipment (UE) may transmit a 200 OK message for an IMS call to a network before the IMS call is accepted by a user. A calling UE may receive the 200 OK message before the IMS call is accepted by the called UE. A network may transmit or transfer the 200 OK message to the calling UE before the IMS call is accepted by the called UE. By performing an early 200 OK and ACK handshake during the ringing phase, media flows can begin earlier, significantly reducing the silence period experienced by both parties, particularly over high-latency GEO satellite access networks.

### CROSS REFERENCE TO RELATED PATENT APPLICATIONS

The present disclosure is part of a non-provisional application claiming the priority benefit of U.S. Patent Application 63/805,374 filed 14 May 2025, the content of which herein being incorporated by reference in its entirety.

### TECHNICAL FIELD

The present disclosure is generally related to wireless communications and, more particularly, to methods and apparatus for reducing call setup latency in mobile communications, including communications over satellite access networks.

### BACKGROUND

Unless otherwise indicated herein, approaches described in this section are not prior art to the claims listed below and are not admitted as prior art by inclusion in this section.

Internet Protocol Multimedia Subsystem (IMS) is a standardized framework within the 3rd Generation Partnership Project (3GPP) for delivering voice and multimedia services over mobile and satellite networks. IMS voice calls rely on the Session Initiation Protocol (SIP) for call control signaling and on the Real-time Transport Protocol (RTP) for media packet delivery.

Starting from 3GPP Release 17, Geostationary Earth Orbit (GEO) satellite access has been incorporated as a 5G access technology. However, GEO satellite systems face inherent limitations, including a one-way signal propagation delay of approximately 285 milliseconds (ms) and an extremely low available data rate of approximately 1–3 kbps. These characteristics result in IMS call setup times that can exceed 93 seconds under existing approaches, rendering such performance incompatible with real-time voice service requirements.

In commercial networks, SIP message sizes typically exceed several hundred bytes. Under conventional 3GPP specifications, the IMS call setup procedure requires a complete signaling exchange — including the INVITE, 100 Trying, 180 Ringing, 200 OK, and ACK messages — before any media transmission can begin. In practice, because users typically answer an incoming call within 5 to 10 seconds of ringing, and calls may be redirected to voicemail if unanswered within 20 to 30 seconds, the window between call acceptance and the start of audible voice is critical.

In conventional IMS procedures, after the called party (callee) presses the accept button, the 200 OK message must travel from the callee to the IMS core and then to the caller, and the caller must send back an ACK message before any voice media can be exchanged. Under GEO satellite access conditions, the combined round-trip delay for these 200 OK and ACK handshakes (denoted as T_200OK + T_ACK) may exceed 12 seconds on the callee side and 6.4 seconds or more on the caller side. During this period, the user hears only silence, leading to a severely degraded user experience.

Accordingly, there exists a need for methods and apparatus that reduce the silence period experienced by both the calling and called parties in IMS calls, particularly in high-latency and bit-rate-limited environments such as GEO satellite access.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to setting IMS calls.

In one aspect, a method may involve an apparatus transmitting an invite message for an Internet Protocol Multimedia Subsystem (IMS) call to a network. The method may also involve the apparatus receiving a 200 OK message for the IMS call from the network before the IMS call is accepted by a second UE that serves as a recipient of the IMS call.

In another aspect, a method may involve an apparatus receiving an invite message for an Internet Protocol Multimedia Subsystem (IMS) call with a first UE from a network. The method may also involve the apparatus transmitting a 200 OK message for the IMS call to the network before accepting the IMS call.

In one further aspect, a method may involve a network apparatus receiving and transferring an invite message for an Internet Protocol Multimedia Subsystem (IMS) call from a first user equipment (UE) to a second UE. The method may also involve transmitting or transferring a 200 OK message for the IMS call to the first UE before the IMS call is accepted by the second UE that serves as a recipient of the IMS call.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale, as some components may be shown to be out of proportion than the size in actual implementation in order to clearly illustrate the concept of the present disclosure.

FIG. 1A illustrates a schematic system diagram of an example Non-Terrestrial Network (NTN) architecture in which a Geostationary Earth Orbit (GEO) satellite operates as a relay node without on-board processing capabilities, in accordance with aspects of the present disclosure.

FIG. 1B illustrates a schematic system diagram of an example Non-Terrestrial Network (NTN) architecture in which a GEO satellite is equipped with full core network functionalities and optionally IMS functionalities on board, in accordance with aspects of the present disclosure.

FIG. 2 is a diagram illustrating examples of setting IMS calls with early 200 OK transmission in accordance with some implementations of the present disclosure.

FIG. 3 is a diagram illustrating examples of setting IMS calls with early 200 OK and ACK transmission in accordance with some implementations of the present disclosure.

FIG. 4 is a diagram illustrating an example of setting an IMS call without early 200 OK transmission according to current standards.

FIG. 5 is a diagram illustrating an example of an IMS call setup procedure in accordance with an implementation of the present disclosure, including the timing of media flows relative to the 200 OK and ACK message exchange.

FIG. 6 is a signaling diagram illustrating an example of an IMS call setup procedure in accordance with an implementation of the present disclosure, including the timing of media flows relative to the 200 OK and ACK message exchange.

FIG. 7 is a block diagram of an example communication system in accordance with an implementation of the present disclosure.

FIG. 8 is a flowchart of an example process performable by a communication apparatus (caller UE) in accordance with an implementation of the present disclosure.

FIG. 9 is a flowchart of an example process performable by a communication apparatus (callee UE) in accordance with an implementation of the present disclosure.

FIG. 10 is a flowchart of another example process performable by a network apparatus in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to setting IMS calls. According to the present disclosure, a number of possible solutions may be implemented separately or jointly. That is, although these possible solutions may be described below separately, two or more of these possible solutions may be implemented in one combination or another.

The techniques described in the disclosure may be applied to a variety of telecommunication systems utilizing IMS communication services, such as current 4G and 5G communications systems, or a next-generation communications system (e.g., 6G). The IMS media described in the disclosure are not limited to voice but also include any real-time media types such as video, text, and applications. The UEs involved in the disclosure are not limited to mobile phones but can also include any device capable of providing IMS communication services, such as wearable devices, vehicular devices, Internet of Things (IoT) devices, and so on.

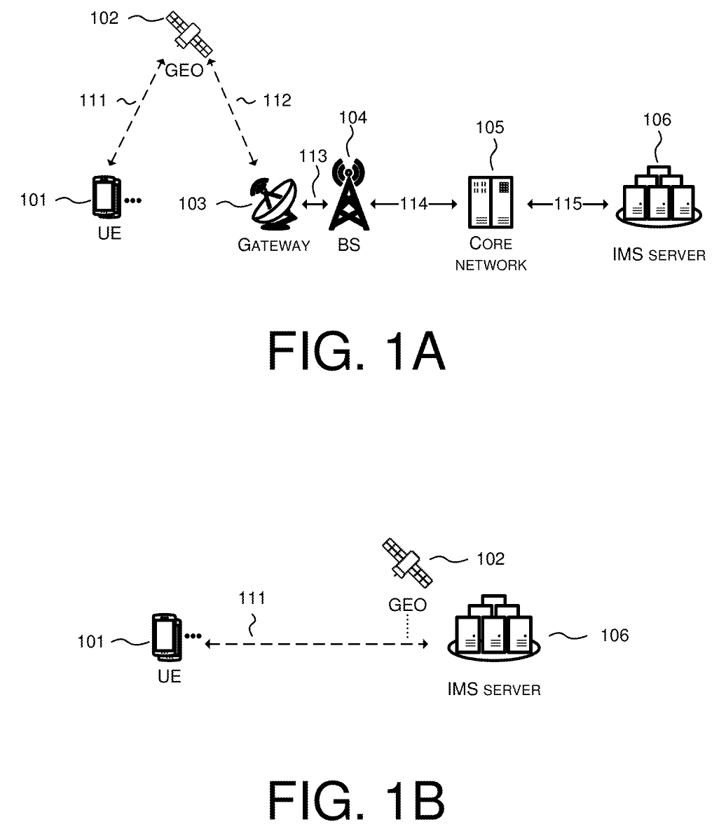

FIGS. 1A and 1B illustrate two schematic system diagrams that illustrate two example 3rd Generation Partnership Project (3GPP) NTN (Non-Terrestrial Network) architectures in accordance with aspects of the present disclosure.

FIG. 1A illustrates an NTN architecture in which the GEO satellite 102 does not include on-board processing capabilities, such as base station functionalities and/or core network (CN) functionalities. In this configuration, the GEO satellite 103 operates primarily as a relay node. Taking the UE transmission (Tx) direction as an example, the UE 101 on the ground first transmits data to the GEO satellite 102 through the service link 111. The GEO satellite 103 then forwards the data to a gateway 103 through the feeder link 112. After reaching the terrestrial network, the data is processed by a base station (BS) 104 via link 113, a core network 105 via link 114, and finally arrives at the IMS server 106 via link 115. The core network 105 may correspond to an evolved packet core (EPC) in a 4G communications system, a 5G core (5GC) in a 5G communications system, or a 6G core (6GC) in a 6G communications system.

FIG. 1B illustrates an NTN architecture in which the GEO satellite 102 is equipped with full CN functionalities, and may additionally include IMS functionalities on board. In this configuration, the communication path between the UE 101 and the IMS server 106 includes at least one GEO service link 111, and the IMS server 106 may be deployed directly on the GEO satellite 103.

It should be noted that the present disclosure is not limited to the NTN architectures illustrated in FIGS. 1A and 1B. Rather, the present disclosure may also be applied to other NTN configurations in which one or more satellites function as intermediary nodes along the data path between the UE and the IMS server.

Note that UE 101 in FIGS. 1A and 1B may comprise one or more UEs, of which at least one UE operates as a mobile originating (MO) terminal of an IMS call through a terrestrial network (TN) and/or a non-terrestrial network (NTN), and at least one UE operates as a mobile terminating (MT) terminal of the same IMS call through a TN and/or an NTN.

The IMS call may be initiated between an MO UE and an MT UE according to one or more of 3GPP technical specifications, RFC 3261 Session Initiation Protocol (SIP), RFC 4566 Session Description Protocol (SDP), and RFC 3550 Real-time Transport Protocol (RTP).

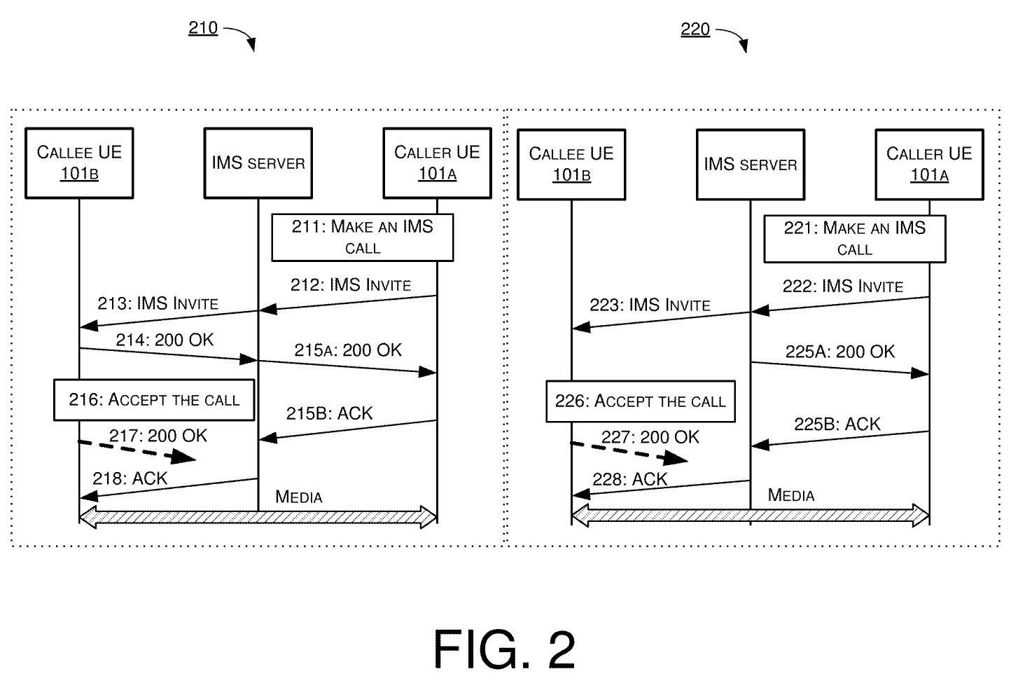

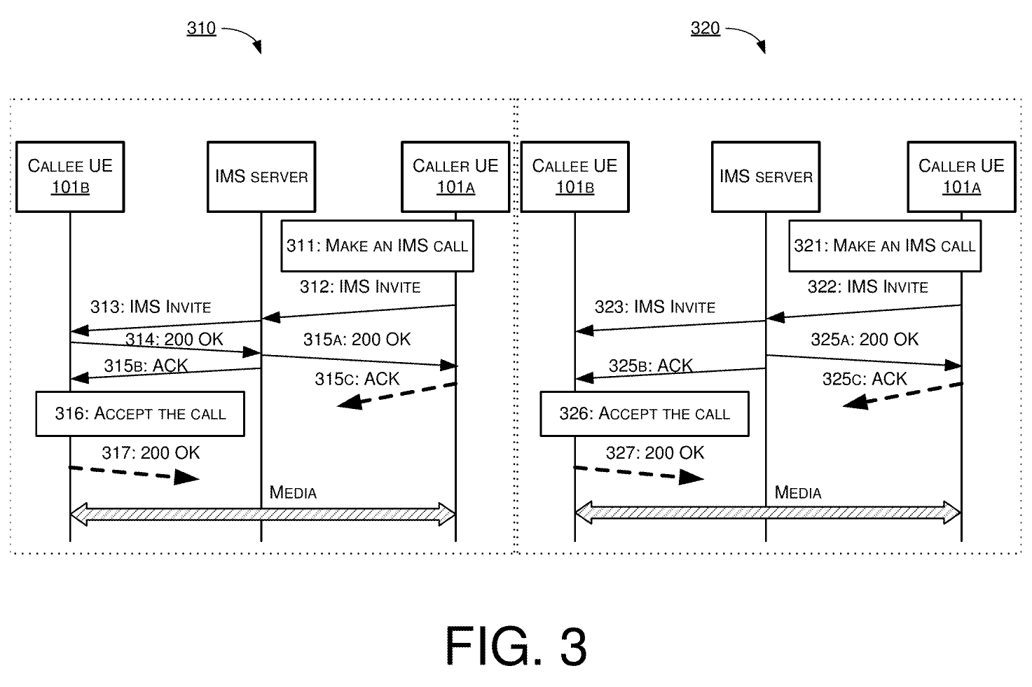

The following figures illustrate four proposed scenarios for reducing IMS call setup latency through early signaling. FIG. 2 presents two scenarios (Scenario 210 and Scenario 220) in which a 200 OK message is transmitted before the callee user accepts the call: in Scenario 210, the early 200 OK is transmitted by the Callee UE itself, whereas in Scenario 220, the early 200 OK is transmitted by the IMS server on behalf of the Callee UE. FIG. 3 presents two corresponding scenarios (Scenario 310 and Scenario 320) that extend the approaches of FIG. 2 by additionally transmitting an ACK message before call acceptance: in Scenario 310, the Callee UE transmits the early 200 OK and the IMS server subsequently transmits the ACK on behalf of the Caller UE, whereas in Scenario 320, the IMS server transmits both the early 200 OK and the ACK without waiting for either party to act. In all four scenarios, the early completion of the 200 OK and ACK handshake during the ringing phase enables media flows to be established sooner, thereby reducing the silence period experienced by both the calling and called parties.

FIG. 2 is a signaling diagram illustrating an implementation of a method for IMS call setup with an early 200 OK transmission, depicting two scenarios (scenario 210 and scenario 220) in which a 200 OK message is sent before a callee user equipment (e.g., UE 101b) accepts the call. This figure serves as an example to highlight the time savings in an IMS call setup procedure, focusing on early 200 OK transmission and the consequent acceleration in media flow establishment. Caller UE 101a and callee UE 101b may be examples of UE 101 in FIGS. 1A and/or 1B. The IMS server in FIG. 2 may be an example of IMS server 106 in FIGS. 1A and/or 1B.

In scenario 210, the following steps are performed.

Step 211: The Caller UE 101a initiates an IMS call, such as a SIP call.

Step 212: The Caller UE 101a transmits an IMS INVITE message (e.g., a SIP INVITE message) to the IMS server.

Step 213: The IMS server forwards the IMS INVITE message to the Callee UE 101b.

Step 214: The Callee UE 101b receives the IMS INVITE message and responds with a 200 OK message to the IMS server before accepting the call. The 200 OK message indicates that a request represented by the IMS INVITE message has succeeded.

Step 215a: The IMS server forwards the 200 OK message to the Caller UE 101a. The Caller UE 101a, receives the 200 OK message. In some implementations, the Caller UE 101a may transmit a media flow to the Callee UE 101b immediately following the reception of the 200 OK message.

Step 215b: The Caller UE 101a responds to the 200 OK message with an ACK message to the IMS server that subsequently forwards the ACK message to the Callee UE 101b. The Caller UE 101a transmits the ACK message to the Callee UE 101b through the IMS server. In some implementations, the Caller UE 101a may transmit a media flow to the Callee UE 101b immediately following the transmission of the ACK message.

Step 216: The user at Callee UE 101b accepts the call (e.g., by pressing an accept button).

Step 217: After the user at Callee UE 101b accepts the call, the Callee UE 101b does not have to transmit a 200 OK message (shown as a dashed arrow) to confirm call acceptance.

In some implementations, the callee UE 101b may transmit a subsequent 200 OK message through the IMS server to the caller UE 101a. In such cases, the caller UE 101a may receive and discard the subsequent 200 OK message, as the caller UE 101a has already received the early 200 OK message transmitted in previous steps (e.g., steps 214 and 215a).

In some implementations, the callee UE 101b may transmit the 200 OK message upon the user accepting the call, while the IMS server receives and drops said 200 OK message to prevent redundant signaling to the caller UE 101a.

In some implementations, the callee UE 101b may generate but refrain from transmitting the 200 OK message at the time the call is accepted, as the signaling handshake has already been completed via the early 200 OK and ACK exchange.

The callee UE 101b may transmit a media flow to the caller UE 101a immediately following the acceptance of the IMS call by the user. This media flow may be initiated in parallel with or immediately following the 200 OK and ACK handshake to reduce the silence period experienced by both parties.

The scenario 220 illustrates early 200 OK transmission by the IMS server on behalf of the Callee UE 101b.

Step 221: The Caller UE 101a initiates an IMS call, such as a SIP call.

Step 222: The Caller UE 101a transmits an IMS INVITE message (e.g., a SIP INVITE message) to the IMS server.

Step 223: The IMS server forwards the IMS INVITE message to the Callee UE 101b. The Callee UE 101b receives the IMS INVITE message.

Step 225a: The IMS server transmits a 200 OK message to the Caller UE 101a. The 200 OK message indicates that a request represented by the IMS INVITE message has succeeded. The Caller UE 101a receives the 200 OK message. In some implementations, the Caller UE 101a may transmit a media flow to the Callee UE 101b immediately following the reception of the 200 OK message.

Step 225b: The Caller UE 101a responds to the 200 OK message with an ACK message to the IMS server that subsequently forwards the ACK message to the Callee UE 101b. The Caller UE 101a transmits the ACK message to the Callee UE 101b through the IMS server. In some implementations, the Caller UE 101a may transmit a media flow to the Callee UE 101b immediately following the transmission of the ACK message.

Step 226: The user at Callee UE 101b accepts the call (e.g., by pressing an accept button).

Step 227: After the user at Callee UE 101b accepts the call, the Callee UE 101b does not have to transmit a 200 OK message (shown as a dashed arrow) to confirm call acceptance.

In some implementations, the callee UE 101b may transmit a subsequent 200 OK message through the IMS server to the caller UE 101a. In such cases, the caller UE 101a may receive and discard the subsequent 200 OK message, as the caller UE 101a has already received the early 200 OK message transmitted in previous steps (e.g., steps 214 and 215a).

In some implementations, the callee UE 101b may transmit the 200 OK message upon the user accepting the call, while the IMS server receives and drops said 200 OK message to prevent redundant signaling to the caller UE 101a.

In some implementations, the callee UE 101b may generate but refrain from transmitting the 200 OK message at the time the call is accepted, as the signaling handshake has already been completed via the early 200 OK and ACK exchange.

The callee UE 101b may transmit a media flow to the caller UE 101a immediately following the acceptance of the IMS call by the user. This media flow may be initiated in parallel with or immediately following the 200 OK and ACK handshake to reduce the silence period experienced by both parties.

In accordance with some implementations of the present disclosure, the message content of the 200 OK message (e.g., in steps 214 and 225a) serves as a critical signaling response to the SIP INVITE for establishing an IMS call. To achieve the objective of reducing call setup latency, particularly in high-latency and bit-rate-limited environments such as GEO satellite access, the content is structured to facilitate early media establishment. The following description outlines the typical content of the 200 OK message as utilized in the proposed schemes. For example, in some implementations, the 200 OK message may comprise one or more of the following:
1. Status Line: The message includes a standard status line, such as SIP/2.0 200 OK, indicating that the session invitation (represented by the IMS INVITE) has been successfully accepted by the signaling entity.
2. Signaling Headers: The message contains essential headers, including Via, From, To, Call-ID, and CSeq, to maintain session consistency and ensure the 200 OK is correctly mapped to the originating SIP INVITE. That is, essential headers in the 200 OK are consistent with headers in the SIP INVITE.
3. Contact Header: A Contact header is provided to specify the uniform resource identifier (URI) where the Callee UE or a network apparatus (e.g., the IMS server) can be reached for subsequent signaling, such as the ACK message.
4. Session Description Protocol (SDP): The message body contains SDP data (e.g., per RFC 4566) which identifies the media parameters required to initiate the RTP media flows (e.g., media flows in FIGS. 2-6). This includes:
   a. Media Attributes: Declaration of audio or video media types and the transport protocol (RTP/AVP). RTP/AVP stands for the Real-Time Transport Protocol Audio/Video Profile. It is a profile defined in RFC 3551.
   b. Connection Information: The Internet Protocol (IP) address and port numbers allocated for the media session.
   c. Codec Negotiation: A list of supported codecs (e.g., for voice, video, text, or multimedia) to be used during the call.
5. Content length (Message Size): The total size of the message content typically exceeds several bytes to accommodate the necessary security and session parameters.

In some implementations, when the IMS server transmits the 200 OK message on behalf of the Callee UE (e.g., as in Scenario 220 of FIG. 2 and Scenario 320 of FIG. 3), the content of the 200 OK message — including the SDP media parameters, codec list, and connection information — may be constructed based on SIP parameters that have been pre-negotiated or pre-configured between the IMS server and the Callee UE. For example, the Callee UE may register with the IMS server and, during or after the registration procedure, provide the IMS server with its supported media capabilities, such as supported codecs, preferred RTP port ranges, and IP address information, so that the IMS server is able to construct a valid and complete 200 OK message without further interaction with the Callee UE at the time of call setup. Similarly, in implementations where the IMS server also transmits an ACK message on behalf of the Caller UE (e.g., as in Scenario 310 of FIG. 3 and Scenario 320 of FIG. 3), the IMS server may rely on pre-negotiated or pre-configured SIP session parameters associated with the Caller UE to generate the ACK message. The use of pre-negotiated or pre-configured parameters enables the IMS server to complete the 200 OK and ACK handshake during the ringing phase without requiring additional round-trip signaling exchanges with either UE, thereby preserving the latency reduction benefits described herein.

The 200 OK message (e.g., in steps 214/215a and 225a) serves as a media flow trigger. Unlike conventional procedures, this specific 200 OK content is transmitted before the user manually accepts the call, enabling the network and the Caller UE to establish voice RTP traffic early.

FIG. 3 is a signaling diagram illustrating an improved IMS call setup method with early ACK message transmission in addition to early 200 OK transmission in accordance with an implementation of the present disclosure, depicting two scenarios (scenario 310 and scenario 320). In contrast to the method shown in FIG. 2, in the proposed method, an ACK message of the 200 OK message is transmitted by the IMS server on behalf of the callee. This early transmission of the ACK enables subsequent media flows to be established earlier, thereby further reducing or eliminating the silence period perceived by the users immediately after call acceptance. Caller UE 101a and callee UE 101b may be examples of UE 101 in FIGS. 1A and/or 1B. The IMS server in the FIG. 3 may be an example of IMS server 106 in FIGS. 1A and/or 1B.

In scenario 310, the following steps are performed.

Step 311: The Caller UE 101a initiates an IMS call, such as a SIP call.

Step 312: The Caller UE 101a transmits an IMS INVITE message (e.g., a SIP INVITE message) to the IMS server.

Step 313: The IMS server forwards the IMS INVITE message to the Callee UE 101b.

Step 314: The Callee UE 101b receives the IMS INVITE message and transmits a 200 OK message to the IMS server before the user at Callee UE 101b accepts the call. The 200 OK message indicates that a request represented by the IMS INVITE message has succeeded.

Step 315a: The IMS server forwards the 200 OK message to the Caller UE 101a. The Caller UE 101a receives the 200 OK message. In some implementations, the Caller UE 101a may transmit a media flow to the Callee UE 101b immediately following the reception of the 200 OK message.

Step 315b: The IMS server transmits an ACK message to the Callee UE 101b.

Step 315c: The Caller UE 101a does not need to transmit another ACK message (shown as a dashed arrow) to the Callee UE 101b upon receiving the 200 OK message. In some implementations, the Caller UE 101a may transmit a media flow to the Callee UE 101b immediately following the transmission of the ACK message.

In some implementations, the Caller UE 101a may transmit a subsequent ACK message through the IMS server to the callee UE 101b. In such cases, the callee UE 101b may receive and discard the subsequent ACK message, as the callee UE 101b has already received the early ACK message transmitted in previous steps (e.g., step 315b).

In some implementations, the Caller UE 101a may transmit the ACK message upon receiving the 200 OK message, while the IMS server receives and drops said ACK message to prevent redundant signaling to the callee UE 101b.

In some implementations, the Caller UE 101a may generate but refrain from transmitting the ACK message upon receiving the 200 OK message, as the signaling handshake has already been completed via the early 200 OK and ACK exchange.

Step 316: The user at Callee UE 101b accepts the call.

Step 317: Because the 200 OK has already been sent in Step 314, after the user at Callee UE 101b accepts the call, Callee UE 101b does not need to retransmit a 200 OK message (shown as a dashed arrow in FIG. 3, indicating the message that would have been sent in the legacy procedure but is not required here).

In some implementations, the callee UE 101b may transmit a subsequent 200 OK message through the IMS server to the caller UE 101a. In such cases, the caller UE 101a may receive and discard the subsequent 200 OK message, as the caller UE 101a has already received the early 200 OK message transmitted in previous steps (e.g., steps 314 and 315a).

In some implementations, the callee UE 101b may transmit the 200 OK message upon the user accepting the call, while the IMS server receives and drops said 200 OK message to prevent redundant signaling to the caller UE 101a.

In some implementations, the callee UE 101b may generate but refrain from transmitting the 200 OK message at the time the call is accepted, as the signaling handshake has already been completed via the early 200 OK and ACK exchange.

The callee UE 101b may transmit a media flow to the caller UE 101a immediately following the acceptance of the IMS call by the user. This media flow may be initiated in parallel with or immediately following the 200 OK and ACK handshake to reduce the silence period experienced by both parties.

The scenario 320 illustrates early 200 OK transmission by the IMS server on behalf of the Callee UE 101b:

Step 321: The Caller UE 101a initiates an IMS call, such as a SIP call.

Step 322: The Caller UE 101a transmits an IMS INVITE message (e.g., a SIP INVITE message) to the IMS server.

Step 323: The IMS server forwards the IMS INVITE message to the Callee UE 101b.

Step 325a: The IMS server transmits a 200 OK message to the Caller UE 101a without waiting for the callee user (i.e., the user of the Callee UE 101b) to accept the call. The 200 OK message indicates that a request represented by the IMS INVITE message has succeeded. The Caller UE 101a receives the 200 OK message. In some implementations, the Caller UE 101a may transmit a media flow to the Callee UE 101b immediately following the reception of the 200 OK message.

Step 325b: The IMS server transmits an ACK message to the Callee UE 101b without waiting for the Caller UE 101a to respond the 200 OK message with an ACK message. In some implementations, the Caller UE 101a may transmit a media flow to the Callee UE 101b immediately following the transmission of the ACK message. In the implementation, the IMS server may send a signal to indicate to the Caller UE 101a the transmission of the ACK message.

Step 325c: The Caller UE 101a receives the 200 OK message and does not need to transmit another ACK message (shown as a dashed arrow) to the IMS server upon receiving the 200 OK message.

In some implementations, the Caller UE 101a may transmit a subsequent ACK message through the IMS server to the callee UE 101b. In such cases, the callee UE 101b may receive and discard the subsequent ACK message, as the callee UE 101b has already received the early ACK message transmitted in previous steps (e.g., step 325b).

In some implementations, the Caller UE 101a may transmit the ACK message upon receiving the 200 OK message, while the IMS server receives and drops said ACK message to prevent redundant signaling to the callee UE 101b.

In some implementations, the Caller UE 101a may generate but refrain from transmitting the ACK message upon receiving the 200 OK message, as the signaling handshake has already been completed via the early 200 OK and ACK exchange.

Step 326: The user at Callee UE 101b accepts the call.

Step 327: Similarly, Callee UE 101b does not need to resend a 200 OK (shown as a dashed arrow), as the 200 OK was already sent by the IMS server in Step 325a.

In some implementations, the callee UE 101b may transmit a subsequent 200 OK message through the IMS server to the caller UE 101a. In such cases, the caller UE 101a may receive and discard the subsequent 200 OK message, as the caller UE 101a has already received the early 200 OK message transmitted in the previous step (e.g., step 325a).

In some implementations, the callee UE 101b may transmit the 200 OK message upon the user accepting the call, while the IMS server receives and drops said 200 OK message to prevent redundant signaling to the caller UE 101a.

In some implementations, the callee UE 101b may generate but refrain from transmitting the 200 OK message at the time the call is accepted, as the signaling handshake has already been completed via the early 200 OK and ACK exchange.

The callee UE 101b may transmit a media flow to the caller UE 101a immediately following the acceptance of the IMS call by the user. This media flow may be initiated in parallel with or immediately following the 200 OK and ACK handshake to reduce the silence period experienced by both parties.

As shown in FIG. 3, by transmitting the 200 OK message before the callee user accepts the call, the signaling exchange required to establish media flow is completed earlier. In particular, the ACK message (Steps 315b/315c or 325b/325c) can be sent and received by the callee UE prior to call acceptance. Accordingly, when the callee user actually picks up the call, media flows (e.g., RTP packets) between the caller UE and the callee UE can commence immediately or with significantly reduced delay, substantially eliminating the silence period that would otherwise be experienced by the users in the conventional method.

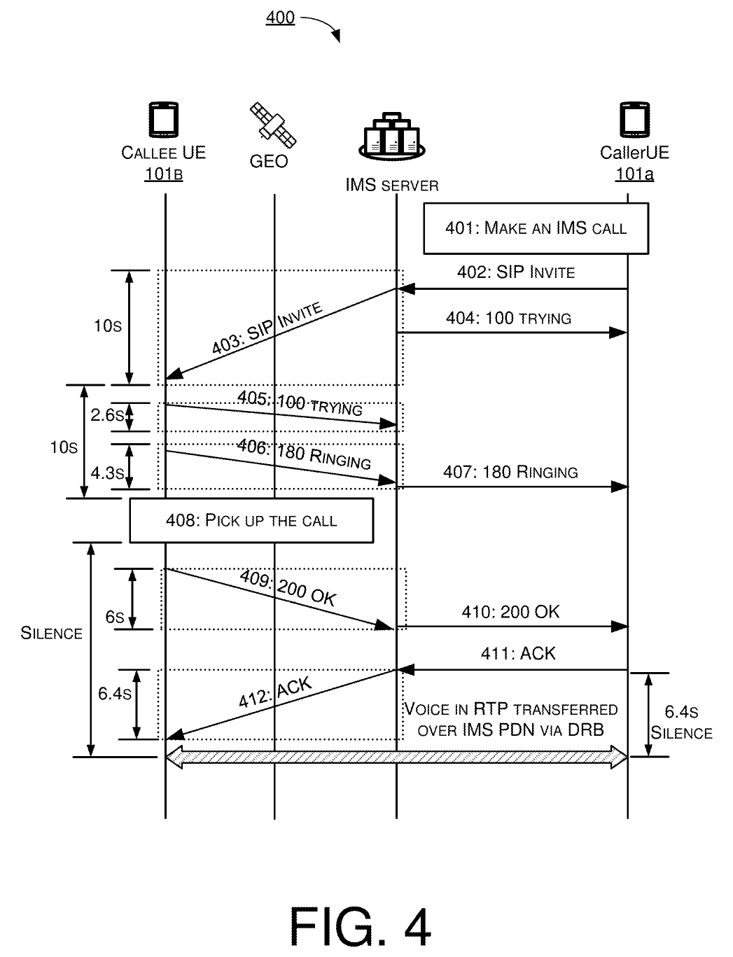

FIG. 4 is a sequence diagram illustrating a conventional IMS (IP Multimedia Subsystem) voice call setup procedure between a Caller UE 101a and a Callee UE 101b via an IMS Server. The Callee UE 101b connects to the IMS Server through a GEO network. The diagram is generally designated by reference numeral 400.

As shown in FIG. 4, the Caller UE 101a initiates an IMS call (step 401) by transmitting a SIP INVITE message (step 402) to the IMS Server. The IMS Server immediately responds with a 100 Trying provisional response (step 404) toward the Caller UE 101a, and simultaneously forwards the SIP INVITE message (step 403) toward the Callee UE 101b. Due to the propagation and processing delay of the non-terrestrial network (i.e., GEO network), the SIP INVITE message (step 403) is received by the Callee UE 101b approximately 10 seconds after the Caller UE 101a originally initiated the call.

Upon receiving the SIP INVITE, the Callee UE 101b returns a 100 Trying response (step 405) to the IMS Server, which is received by the IMS Server approximately 2.6 seconds later. The Callee UE 101b then generates a 180 Ringing response (step 406) to indicate that the device is alerting the user. This 180 Ringing message is received by the IMS Server approximately 4.3 seconds after the 100 Trying was sent, and is subsequently forwarded as step 407 to the Caller UE 101a. At this point, the Caller UE 101a begins playing a ringback tone to the caller.

When the callee user picks up the call (step 408), the Callee UE 101b transmits a 200 OK response (step 409) to the IMS Server. The IMS Server receives this 200 OK message approximately 6 seconds later (denoted by T_200OK=6) and forwards it as step 410 to the Caller UE 101a. The Caller UE 101a then sends an ACK message (step 411) to the IMS Server, which relays the ACK (step 412) to the Callee UE 101b approximately 6.4 seconds (denoted by T_ACK=6.4) after the ACK was sent. Once the ACK is received by the Callee UE 101b, bidirectional voice data (voice in RTP) can be transmitted over the IMS Packet Data Network (PDN) via a Data Radio Bearer (DRB), as shown in the lower portion of FIG. 4.

However, in this conventional procedure, there exists a significant silence period experienced by both parties after the callee picks up the call. As illustrated in FIG. 4, the Callee UE 101b experiences a silence period (labeled “SILENCE”) from the moment the callee answers the call until the ACK message is received and voice data can begin flowing—a period lasting approximately 12 seconds (i.e., the combined T_200OK and T_ACK delay). In addition, the Caller UE 101a also experiences a silence period of approximately 6.4 seconds (labeled “6.4s SILENCE” on the right side of FIG. 4), from the time the 200 OK is forwarded to the Caller UE 101a until voice data actually arrives. These silence periods severely degrade the user experience.

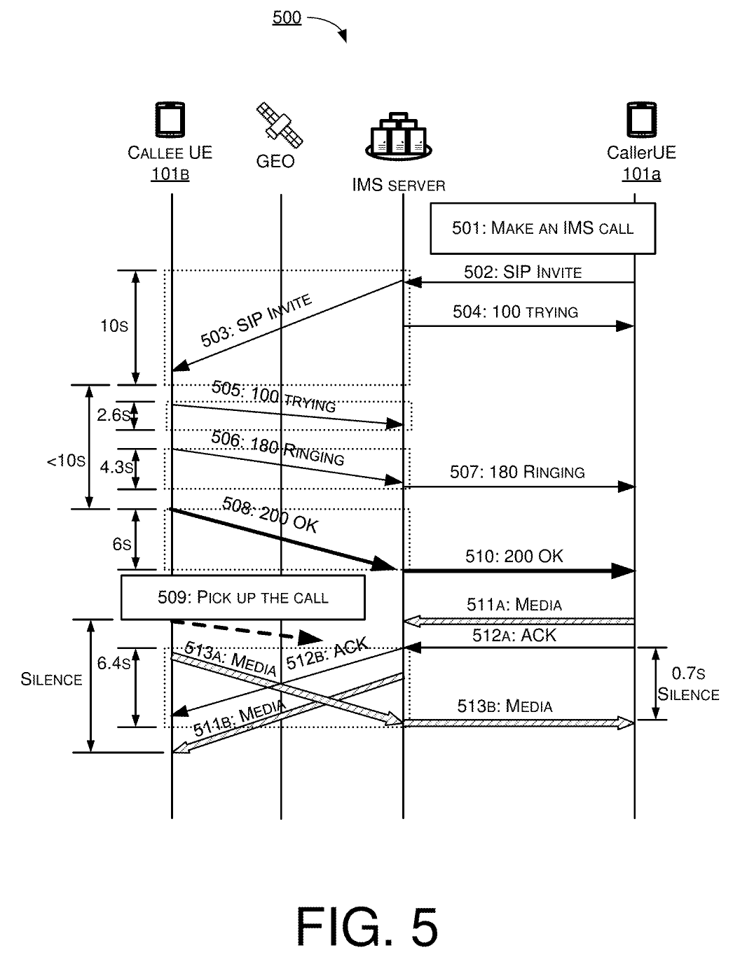

FIG. 5 is a sequence diagram illustrating an optimized IMS voice call setup procedure in accordance with an embodiment of the present disclosure, in which the Callee UE 101b is connected to the IMS Server via a GEO NTN satellite, while the Caller UE 101a remains connected via the IMS Server over a conventional network path. The diagram is generally designated by reference numeral 500.

As shown in FIG. 5, the Caller UE 101a initiates an IMS call (step 501) and transmits a SIP INVITE message (step 502) to the IMS Server. The IMS Server responds with 100 Trying (step 504) toward the Caller UE 101a, and forwards a SIP INVITE (step 503) through the GEO satellite toward the Callee UE 101b. Due to the GEO satellite's propagation delay, the SIP INVITE (step 503) is received by the Callee UE 101b after a delay of less than 10 seconds. The Callee UE 101b then sends 100 Trying (step 505) and 180 Ringing (step 506) back via the GEO satellite to the IMS Server, incurring delays of approximately 2.6 seconds and 4.3 seconds respectively, and the IMS Server forwards the 180 Ringing (step 507) to the Caller UE 101a.

In the proposed embodiment, rather than waiting for the callee user to physically pick up the call before sending a 200 OK, the Callee UE 101b proactively transmits a 200 OK response (step 508) to the IMS Server immediately after—or in parallel with—sending the 180 Ringing response (step 506), while the device (i.e., Callee UE 101b) is still alerting the callee user. The IMS Server receives the 200 OK (step 508) approximately 6 seconds after the 180 Ringing was sent and immediately forwards a 200 OK (step 510) to the Caller UE 101a. The Caller UE 101a then sends an ACK message (step 512a) to the IMS Server and, upon receiving the 200 OK, also begins sending a media flow (RTP voice) immediately (step 511a) toward the IMS Server.

On the callee side, the callee user picks up the call (step 509). The IMS Server relays both the ACK message (step 512b) and media packets (in the media flow) (step 511b) via the GEO satellite to the Callee UE 101b. Simultaneously, the Callee UE 101b starts sending a media flow (step 513a) via the GEO satellite toward the Caller UE 101a (step 513b). Because the 200 OK / ACK handshake is completed in parallel with the ringing phase—before the callee user has actually answered—the silence period on the Callee UE 101b side is reduced from approximately 12 seconds to approximately 6.4 seconds. More significantly, the silence period on the Caller UE 101a side is dramatically reduced to only approximately 0.7 s (i.e., voice frame time plus one-way propagation delay), compared with 6.4 seconds in the related art shown in FIG. 4.

In this embodiment, because the Callee UE 101b is the node attached to the GEO NTN with the highest satellite propagation delay (approximately 285 ms one-way), performing the early 200 OK / ACK handshake during the ringing phase yields the greatest improvement in perceived call quality for both the caller and the callee.

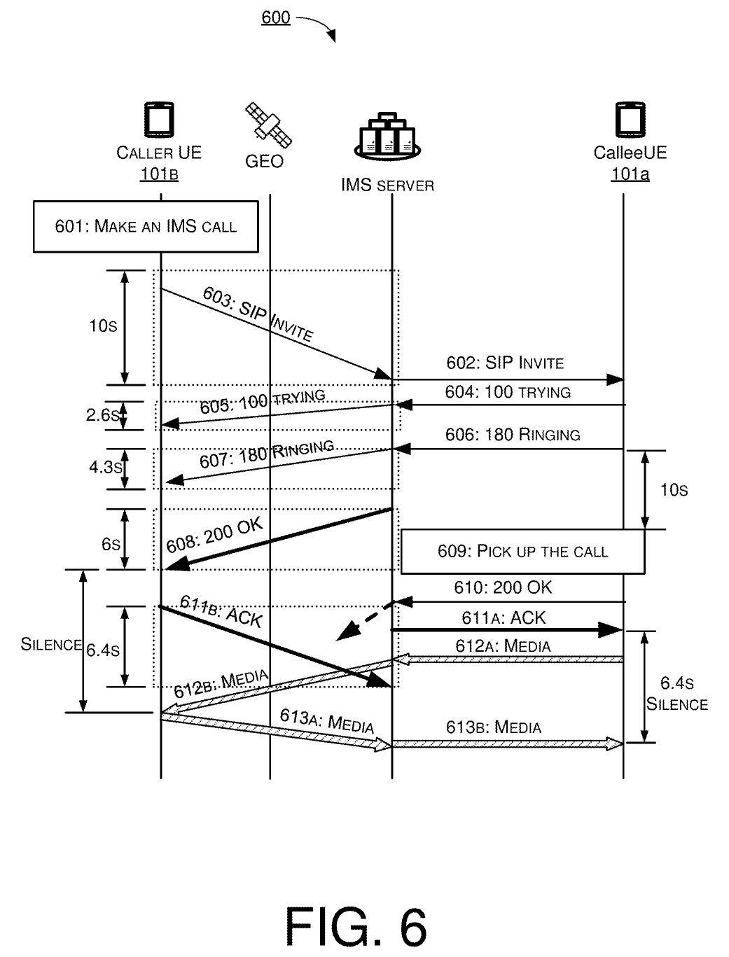

While FIG. 5 illustrates the scenario in which the Callee UE 101b is the node connected to the IMS Server via the GEO NTN satellite link, it will be appreciated that the high-latency characteristics of the GEO NTN may equally apply to the originating side of the call. FIG. 6 illustrates another embodiment of the present disclosure directed to the complementary scenario, in which the Caller UE 101b is the node connected to the IMS Server via the GEO NTN satellite, while the Callee UE 101a is connected via a conventional terrestrial network path. In both scenarios, the underlying optimization principle remains the same: by performing the 200 OK / ACK handshake in parallel with the ringing phase—rather than waiting until after the callee user physically answers the call—the silence period experienced by the GEO NTN-connected UE is substantially reduced, thereby improving the perceived voice call quality for both parties regardless of which end of the call is subject to the GEO satellite propagation delay.

FIG. 6 is a sequence diagram illustrating another optimized IMS voice call setup procedure in accordance with a further embodiment of the present disclosure, in which the Caller UE 101b is connected to the IMS Server via the GEO NTN satellite, while the Callee UE 101a remains connected via the IMS Server over a conventional network path. It should be noted that in FIG. 6, the roles of Caller and Callee are labeled with the UE identifiers reversed compared to FIG. 5, reflecting the scenario where the originating UE is the one experiencing the GEO satellite link. The diagram is generally designated by reference numeral 600.

As shown in FIG. 6, the Caller UE 101b initiates an IMS call (step 601). Due to the GEO satellite link, the SIP INVITE message travels via the GEO satellite to the IMS Server (step 603), incurring a propagation delay of approximately 10 seconds. The IMS Server forwards the SIP INVITE (step 602) to the Callee UE 101a. The Callee UE 101a responds with 100 Trying (step 604), and the IMS server forwards 100 Trying (step 605) through the GEO satellite to the Caller UE 101b. The Caller UE 101b receives the 100 Trying approximately 2.6 seconds after the 100 Trying was transmitted at the IMS Server. The Callee UE 101a returns 180 Ringing (step 606) to the IMS Server, which is forwarded via the GEO satellite as step 607 toward the Caller UE 101b. The Caller UE 101b receives the 180 Ringing approximately 4.3 seconds after the 180 Ringing was transmitted at the IMS Server.

In this embodiment, the IMS Server (or the Callee UE 101a) proactively transmits a 200 OK message (step 608) via the GEO satellite toward the Caller UE 101b immediately after—or in conjunction with—sending the 180 Ringing (step 606), without waiting for the callee user to answer. The Caller UE 101b receives the 200 OK (step 608) approximately 6 seconds later and sends an ACK message (step 611b) back via the GEO satellite to the IMS Server. Simultaneously, the Callee UE 101a picks up the call (step 609) and transmits a 200 OK message (referred to as a second 200 OK message) to the IMS Server. The IMS Server receives and drops the second 200 OK message (step 610) and transmits an ACK (step 611a) to the Callee UE 101a in response to the second 200 OK message.

Since the IMS server has transmitted the ACK in step 611a, the Caller UE 101b receives the 200 OK message in step 608 and does not need to transmit another ACK message in step 611b.

In step 611b, in some implementations, the Caller UE 101b may transmit a subsequent ACK message through the IMS server to the callee UE 101a. In such cases, the callee UE 101a may receive and discard the subsequent ACK message, as the callee UE 101a has already received the early ACK message transmitted in previous steps (e.g., step 611a).

In step 611b, in some implementations, the Caller UE 101b may transmit the ACK message upon receiving the 200 OK message, while the IMS server receives and drops said ACK message to prevent redundant signaling to the callee UE 101a.

In step 611b, in some implementations, the Caller UE 101b may generate but refrain from transmitting the ACK message upon receiving the 200 OK message, as the signaling handshake has already been completed via the early 200 OK and ACK exchange.

Media (RTP voice) packets begin flowing in both directions as quickly as possible. The Callee UE 101a starts sending a media flow (step 612a) to the IMS Server, which relays it via the GEO satellite to the Caller UE 101b (step 612b). The Caller UE 101b also begins sending a media flow (step 613a) toward the IMS Server, which forwards it to the Callee UE 101a (step 613b).

In this scenario, because the Caller UE 101b is connected via the high-latency GEO NTN link, the silence period experienced by the Caller UE 101b is reduced from what would otherwise be approximately 12.8 seconds (the round-trip delay for the 200 OK/ACK handshake plus the GEO propagation delay) to approximately 6.4 seconds—matching the callee silence reduction achieved in the scenario of FIG. 5. The Callee UE 101a's silence period also remains at approximately 6.4 seconds. Consequently, both the callee-side and caller-side voice communication are established more quickly, resulting in a substantially improved user experience for IMS voice calls over GEO NTN.

By transmitting the 200 OK message before the IMS call is accepted by the called user — and by initiating voice RTP media flows in parallel with or immediately following the 200 OK and ACK handshake — the present disclosure achieves several technical effects:

The silence period experienced by the callee after answering the call may be reduced (e.g., from approximately 12 seconds to approximately 6 seconds). The silence period experienced by the caller may be reduced (e.g., from approximately 6.4 seconds to approximately 0.7 seconds). These improvements are achieved without modifying the fundamental SIP call flow architecture, by initiating the 200 OK and ACK handshake in parallel with the ringing phase, thereby allowing voice RTP traffic to be transmitted earlier.

### Illustrative Implementations

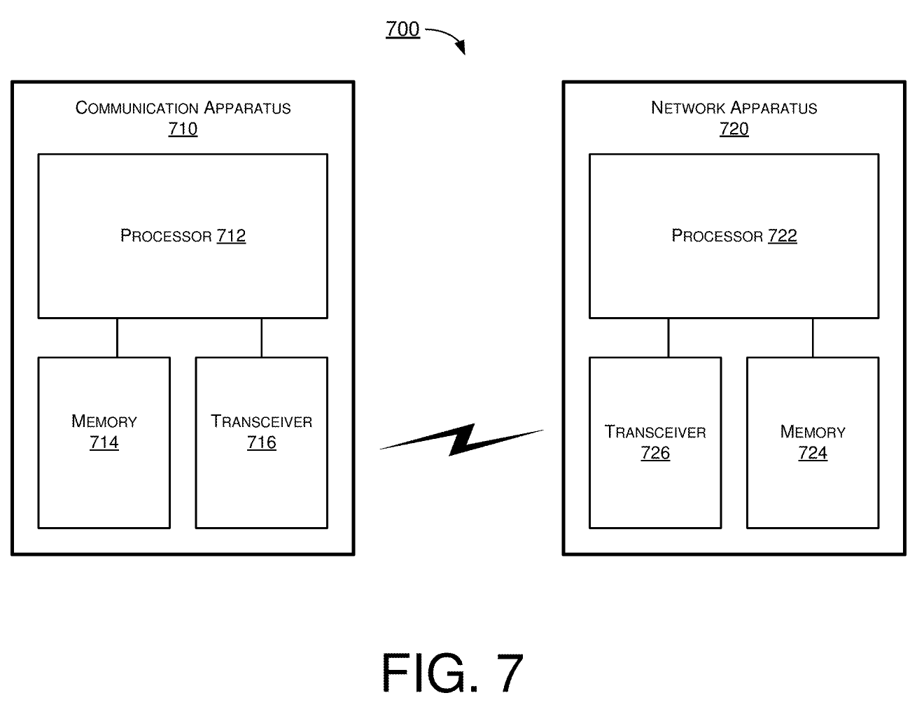

FIG. 7 illustrates an example communication system 700 having at least an example communication apparatus 710 and an example network apparatus 720 in accordance with an implementation of the present disclosure. Each of the communication apparatus 710 and network apparatus 720 may perform various functions to implement schemes, techniques, processes, and methods described herein of setting IMS calls, including scenarios/schemes described above, as well as processes 810, 820, 910, and 920 described below.

Communication apparatus 710 may be a part of an electronic apparatus, which may be a UE such as a portable or mobile apparatus, a wearable apparatus, a wireless communication apparatus, or a computing apparatus. For instance, communication apparatus 710 may be implemented in a smartphone, a smartwatch, a personal digital assistant, a digital camera, or a computing equipment such as a tablet computer, a laptop computer, or a notebook computer. Communication apparatus 710 may also be a part of a machine type apparatus, which may be an IoT, NB-IoT, or IIoT apparatus, such as an immobile or a stationary apparatus, a home apparatus, a wire communication apparatus, or a computing apparatus. For instance, communication apparatus 710 may be implemented in a smart thermostat, a smart fridge, a smart door lock, a wireless speaker, or a home control center. Alternatively, communication apparatus 710 may be implemented in the form of one or more integrated-circuit (IC) chips, such as, for example, and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7, such as a processor 712, for example. Communication apparatus 710 may further include one or more other components not pertinent to the proposed scheme of the present disclosure (e.g., internal power supply, display device, and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a base station, a small cell, an MME, a P-GW, an S-GW, an IMS server, a media server, a P-CSCF, an I-CSCF, an S-CSCF, an AMF, an HSS, a satellite, a router, or a gateway. For instance, network apparatus 720 may be implemented in an eNB in an LTE network, in a gNB in a 5G/NR, IoT, NB-IoT or IIoT network, or in a satellite or base station in a 6G network. Network apparatus 720 may include at least some of those components shown in FIG. 7, such as a processor 722, for example. Processor 722 may further include protocol stacks and a set of control functional modules and circuits. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of the processor 712 and processor 722 may be implemented in the form of one or more single-core processors, one or more multi-core processors, or one or more CISC processors. That is, even though a singular term “a processor” is used herein to refer to processor 712 and processor 722, each of the processor 712 and processor 722 may include multiple processors in some implementations and a single processor in other implementations in accordance with the present disclosure. In another aspect, each of the processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 712 and processor 722 is a special-purpose machine specifically designed, arranged, and configured to perform specific tasks in a device (e.g., as represented by communication apparatus 710) and a network (e.g., as represented by network apparatus 720) in accordance with various implementations of the present disclosure.

In some implementations, communication apparatus 710 may also include a memory 714 coupled to processor 712 and capable of being accessed by processor 712 and storing data therein. In some implementations, communication apparatus 710 may further include a transceiver 716 coupled to processor 712 and capable of wirelessly transmitting and receiving data. In some implementations, transceiver 716 may be capable of wirelessly communicating with different types of UEs and/or wireless networks of different RATs, e.g., 2G GSM, 3G UMTS, 4G LTE, 5G NR, and/or 6G.

In some implementations, network apparatus 720 may further include a memory 724 coupled to processor 722 and capable of being accessed by processor 722 and storing data therein, and a transceiver 726 coupled to processor 722 and capable of wirelessly transmitting and receiving data. Accordingly, communication apparatus 710 and network apparatus 720 may wirelessly communicate with each other via transceiver 716 and transceiver 726, respectively.

For illustrative purposes and without limitation, descriptions of capabilities of the communication apparatus 710 and network apparatus 720 are provided below with processes 800, 900, and 1000. In which, communication apparatus 710 is implemented in or as a communication apparatus or a UE, and network apparatus 720 is implemented in or as a network node of a communication network.

### Illustrative Processes

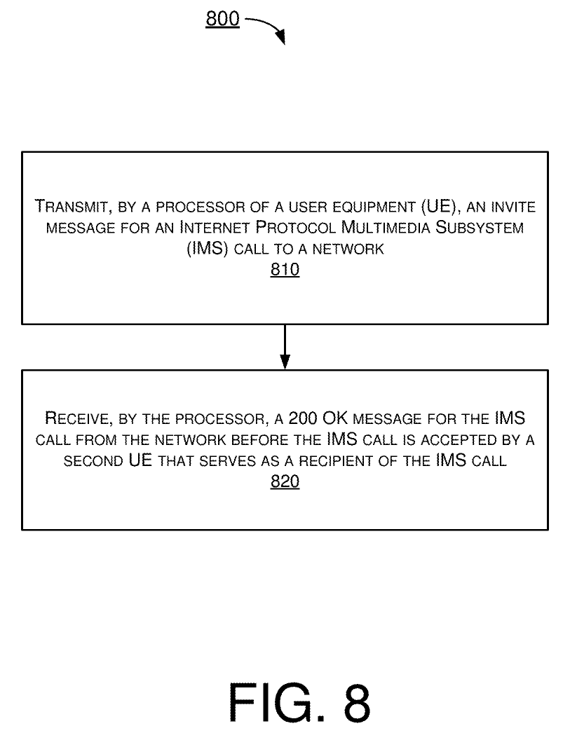

FIG. 8 illustrates an example process 800 in accordance with an implementation of the present disclosure. Process 800 may be an example implementation of the above scenarios/schemes, whether partially or completely, with respect to setting IMS calls. Process 800 may represent an aspect of the implementation of features of communication apparatus 710. Process 800 may include one or more operations, actions, or functions as illustrated by one or more of blocks 810, and 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE (e.g., UE 101, 101a, or 101b) or machine-type devices. Solely for illustrative purposes and without limitation, process 800 is described below in the context of communication apparatus 710 as a UE. Process 800 may begin at block 810.

At block 810, process 800 may involve processor 712 of communication apparatus 710 transmitting, via transceiver 716, an invite message for an Internet Protocol Multimedia Subsystem (IMS) call to a network (e.g., network apparatus 720). The network apparatus 720 may comprise IMS server 106 in FIGS. 1A, 1B, 2, 3, 5, or 6. Process 800 may proceed from block 810 to block 820.

In some implementations, process 800 may involve processor 712 receiving, via transceiver 716, a 200 OK message for the IMS call from the network before the IMS call is accepted by a second UE that serves as a recipient of the IMS call.

In some implementations, process 800 may involve processor 712 transmitting, via transceiver 716, an ACK message to the network in response to the 200 OK message.

In some implementations, process 800 may involve processor 712 transmitting, via transceiver 716, to the network a second media flow upon receiving the 200 OK message.

In some implementations, process 800 may involve processor 712 receiving, via transceiver 716, from the network a first media flow after receiving the 200 OK message.

In some implementations, the invite message is a Session Initiation Protocol (SIP) INVITE message.

In some implementations, the 200 OK message is generated by the network or the second UE.

In some implementations, at least one of the first UE or the second UE communicates with the network through a Geostationary Earth Orbit (GEO) Non-Terrestrial Network (NTN) access.

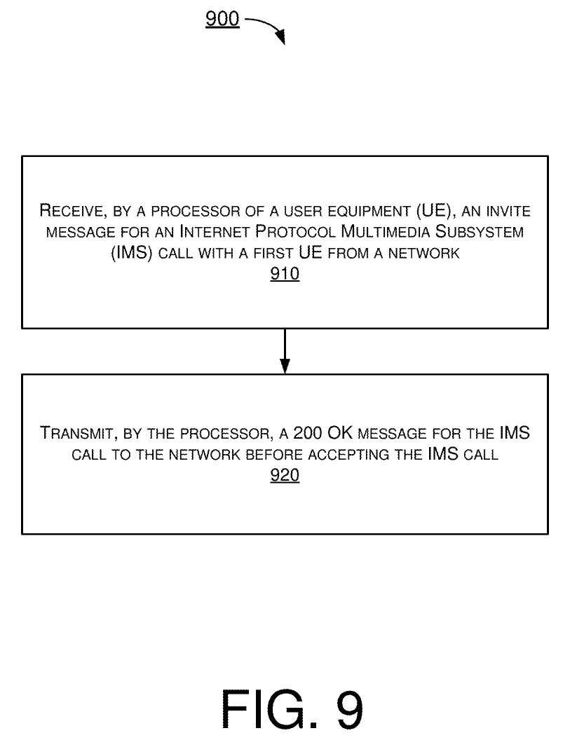

FIG. 9 illustrates an example process 900 in accordance with an implementation of the present disclosure. Process 900 may be an example implementation of the above scenarios/schemes, whether partially or completely, with respect to setting IMS calls. Process 900 may represent an aspect of the implementation of features of communication apparatus 710. Process 900 may include one or more operations, actions, or functions as illustrated by one or more of blocks 910, and 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 710 or any suitable UE (e.g., UE 101, 101a, or 101b) or machine-type devices. Solely for illustrative purposes and without limitation, process 900 is described below in the context of communication apparatus 710 as a UE. Process 900 may begin at block 910.

At block 910, process 900 may involve processor 712 of communication apparatus 710 receiving, via transceiver 716, an invite message for an Internet Protocol Multimedia Subsystem (IMS) call with a first UE from a network (e.g., network apparatus 720). The network apparatus 720 may comprise IMS server 106 in FIGS. 1A, 1B, 2, 3, 5, or 6. Process 900 may proceed from block 910 to block 920.

At block 920, process 900 may involve processor 712 transmitting, via transceiver 716 a 200 OK message for the IMS call to the network before accepting the IMS call.

In some implementations, process 900 may involve processor 712 transmitting, via transceiver 716, to the network a first media flow after transmitting the 200 OK message.

In some implementations, process 900 may involve processor 712 receiving, via transceiver 716, an ACK message from the network, wherein the ACK message is received in response to the 200 OK message.

In some implementations, process 900 may involve processor 712 receiving, via transceiver 716, from the network a second media flow after transmitting the 200 OK message.

In some implementations, the invite message is a Session Initiation Protocol (SIP) INVITE message.

In some implementations, the 200 OK message is generated by the network or the second UE.

In some implementations, at least one of the first UE or the second UE communicates with the network through a Geostationary Earth Orbit (GEO) Non-Terrestrial Network (NTN) access.

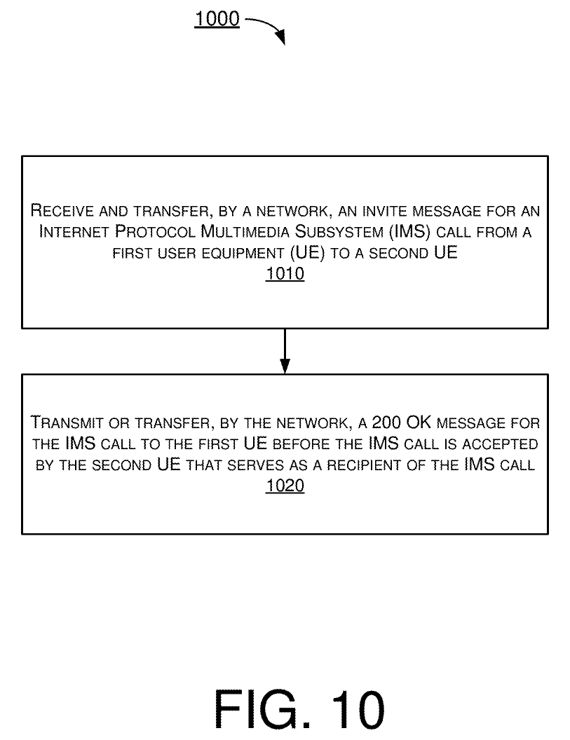

FIG. 10 illustrates an example process 1000 in accordance with an implementation of the present disclosure. Process 1000 may be an example implementation of the above scenarios/schemes, whether partially or completely, with respect to setting IMS calls. Process 1000 may represent an aspect of the implementation of features of network apparatus 720. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 720 or any network entity in the 4G, 5G, or 6G network, including a base station, a small cell, an IMS server, a media server, an MME, a P-GW, an S-GW, a P-CSCF, an I-CSCF, an S-CSCF, an AMF, or an HSS. Solely for illustrative purposes and without limitation, process 1000 is described below in the context of network apparatus 720 as a network node. Process 1000 may begin at block 1010.

At block 1010, process 1000 may involve processor 722 of network apparatus 720 receiving and transferring, via transceiver 726, an invite message for an Internet Protocol Multimedia Subsystem (IMS) call from a first user equipment (UE) to a second UE. Process 1000 may proceed from block 1010 to block 1020.

At block 1020, process 1000 may involve processor 722 transmitting or transferring, via transceiver 726, a 200 OK message for the IMS call to the first UE before the IMS call is accepted by the second UE that serves as a recipient of the IMS call.

In some implementations, process 1000 may involve processor 722 receiving and transferring, via transceiver 726, from the second UE to the first UE, a first media flow after transmitting or transferring the 200 OK message.

In some implementations, process 1000 may involve processor 722 skipping another 200 OK message in an event that the IMS call is accepted by the second UE.

In some implementations, process 1000 may involve processor 722 receiving and transferring, by the network, an ACK message from the first UE to the second UE in response to the 200 OK message; or transmitting, by the network, an ACK message from the network to the second UE in response to the 200 OK message.

In some implementations, process 1000 may involve processor 722 receiving and transferring, by the network, a second media flow from the first UE to the second UE after transmitting or transferring the 200 OK message.

In some implementations, the 200 OK message is generated by the network or the second UE.

In some implementations, at least one of the first UE or the second UE communicates with the network through a Geostationary Earth Orbit (GEO) Non-Terrestrial Network (NTN) access.

### Additional Notes

The herein-described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the

introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually

any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a first user equipment (UE), an invite message for an Internet Protocol Multimedia Subsystem (IMS) call to a network; and
receiving, by the processor, a 200 OK message for the IMS call from the network before the IMS call is accepted by a second UE that serves as a recipient of the IMS call.

2. The method of claim 1, further comprising:
receiving, by the processor, from the network a first media flow after receiving the 200 OK message.

3. The method of claim 1, further comprising:
transmitting, by the processor, an ACK message to the network in response to the 200 OK message.

4. The method of claim 1, further comprising:
transmitting, by the processor, to the network a second media flow upon receiving the 200 OK message.

5. The method of claim 1, wherein the invite message is a Session Initiation Protocol (SIP) INVITE message.

6. The method of claim 1, wherein the 200 OK message is generated by the network or the second UE.

7. The method of claim 1, wherein at least one of the first UE or the second UE communicates with the network through a Geostationary Earth Orbit (GEO) Non-Terrestrial Network (NTN) access.

8. A method, comprising:
receiving, by a processor of a second user equipment (UE), an invite message for an Internet Protocol Multimedia Subsystem (IMS) call with a first UE from a network; and
transmitting, by the processor, a 200 OK message for the IMS call to the network before accepting the IMS call.

9. The method of claim 8, further comprising:
transmitting, by the processor, to the network a first media flow after transmitting the 200 OK message.

10. The method of claim 8, further comprising:
receiving, by the processor, an ACK message from the network, wherein the ACK message is received in response to the 200 OK message.

11. The method of claim 8, further comprising:
receiving, by the processor, from the network a second media flow after transmitting the 200 OK message.

12. The method of claim 8, wherein the invite message is a Session Initiation Protocol (SIP) INVITE message.

13. The method of claim 8, wherein the 200 OK message is generated by the network or the second UE.

14. The method of claim 8, wherein at least one of the first UE or the second UE communicates with the network through a Geostationary Earth Orbit (GEO) Non-Terrestrial Network (NTN) access.

15. A method, comprising:
receiving and transferring, by a network, an invite message for an Internet Protocol Multimedia Subsystem (IMS) call from a first user equipment (UE) to a second UE; and
transmitting or transferring, by the network, a 200 OK message for the IMS call to the first UE before the IMS call is accepted by the second UE that serves as a recipient of the IMS call.

16. The method of claim 15, further comprising:
receiving and transferring, by the network, from the second UE to the first UE, a first media flow after transmitting or transferring the 200 OK message.

17. The method of claim 15, further comprising:
skipping, by the network, another 200 OK message in an event that the IMS call is accepted by the second UE.

18. The method of claim 15, further comprising:
receiving and transferring, by the network, an ACK message from the first UE to the second UE in response to the 200 OK message; or
transmitting, by the network, an ACK message from the network to the second UE in response to the 200 OK message.

19. The method of claim 15, further comprising:
receiving and transferring, by the network, a second media flow from the first UE to the second UE after transmitting or transferring the 200 OK message.

20. The method of claim 15, wherein the 200 OK message is generated by the network or the second UE.
